(19) United States
(12) Patent Application Publication
(10) Pub. No.: US 2018/0144154 A1
(43) Pub. Date: May 24, 2018

(54) PROVIDING HEALTHCARE-RELATED INFORMATION

(71) Applicant: Microsoft Technology Licensing, LLC, Redmond, WA (US)

(72) Inventors: Gil Shacham, Ramat HaSharon (IL); Ryen William White, Woodinville, WA (US); Hadas Bitran, Ramat HaSharon (IL); Shahar Yekutiel, Tel Aviv (IL); Elad Yom-Tov, Hoshaya (IL); Christopher R. Jones, Seattle, WA (US); Todd Eric Holmdahl, Redmond, WA (US)

(73) Assignee: Microsoft Technology Licensing, LLC, Redmond, WA (US)

(21) Appl. No.: 15/359,418

(22) Filed: Nov. 22, 2016

(51) Int. Cl. G06F 21/62; H04L 29/06; G06F 19/00; G06F 17/30

(52) U.S. Cl. CPC G06F 21/6245; H04L 63/06; G06F 19/322; H04L 63/10; H04L 63/04; H04L 63/061; G06F 17/30864

(57) ABSTRACT

Examples are disclosed that relate to providing healthcare-related information. One example provides a computing device comprising a logic machine and a storage machine holding instructions executable by the logic machine to receive an input of information regarding a health state of a user, obtain, based upon the information regarding the health state of the user, an inference of a possible health condition of the user, output a notification of the inference, the notification comprising a first representation of the inference, receive data representing a mechanism for authorizing a healthcare practitioner to access a second representation of the inference, and output a user-selectable control for triggering the mechanism. The instructions may be further executable to receive an input via the user-selectable control triggering the mechanism, and, in response, send authorization to provide the healthcare practitioner with access to the second representation of the inference.

### BACKGROUND

Prior to the wide availability of health-related content available on computer networks, people with health-related questions would seek to consult with a physician to obtain information relevant to a health-concern. Today, in view of this availability, people with health-related questions often use a search engine to locate potentially relevant information via a computer network, prior to or even instead of consulting with a physician.

### SUMMARY

Examples are disclosed that relate to providing healthcare-related information to a healthcare practitioner via a computer network based upon user behaviors. One example provides a computing device comprising a logic machine and a storage machine holding instructions executable by the logic machine to receive an input of information regarding a health state of a user: obtain, based upon the information regarding the health state of the user, an inference of a possible health condition of the user, output a notification of the inference, the notification comprising a first representation of the inference; receive data representing a mechanism for authorizing a healthcare practitioner to access a second representation of the inference; and output a user-selectable control for triggering the mechanism. The instructions may be further executable to receive an input via the user-selectable control triggering the mechanism, and, in response, send authorization to provide the healthcare practitioner with access to the second representation of the inference.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1C show a flowchart illustrating an example method of providing representations of an inference of a possible health condition to a user computing device and a healthcare computing device.

FIG. 2 shows an example user interface operable to receive search requests associated with a user.

FIG. 3 shows an example user interface for a search engine, and illustrates a user input of healthcare-related information.

FIG. 4 shows an example user interface operable to display mechanisms to grant or deny authorization for a healthcare practitioner to access possible health condition inferences determined based upon user behaviors.

FIG. 5 shows an example user interface operable to display representations of possible health condition inferences.

FIG. 6 shows an example system for carrying out the method of FIGS. 1A-1C.

FIG. 7 shows a block diagram of an example computing device.

### DETAILED DESCRIPTION

As described above, people with healthcare-related questions often may seek healthcare-related information in a self-directed manner by supplying queries to a search engine. For example, a user experiencing possible symptoms may query the search engine with terms regarding the symptoms to find information regarding potential causes of and treatments for those symptoms.

However, various issues may arise in such a self-directed approach. For example, a user may not understand the significance of a set of symptoms and/or their possible relation to one another. Thus, search results returned for each query in isolation may not comprise information relevant to an actual condition of the person. Also, the information the user does obtain may include unfamiliar medical terminology, further compounding user misunderstanding. Further, the information obtained by the user may include alarming content. This may induce user anxiety, which potentially may not be merited. Still further, the user may report inaccurate information to a healthcare practitioner based upon the search results, which may complicate diagnosis by the healthcare practitioner.

Accordingly, examples are disclosed that relate to a server computing system implementing health-aware logic to identify possible health conditions based upon user computing interactions, such as searches performed by the user. As described in further detail below, the server computing system may receive from a user computing device information regarding a health state of the user, such as user search engine queries that include health-related search terms, as well as information on the search results accessed by the user, and/or potentially other health-related information. The server computing system may include logic for determining an inference of a possible health condition of the user based on the information regarding the health state of the user.

Further, the server computing system generates a first representation of the inference configured for provision to the user. The first representation is configured to provide a first set of information configured to describe the possible health condition in terms understandable by non-medical users. The first representation also may comprise a mechanism for authorizing the healthcare practitioner to access a second representation of the possible health condition, which may be generated by the server computing system for provision to the healthcare practitioner. The second representation may explicitly identify the possible health condition in terms tailored to a healthcare practitioner. The second representation fluffier may include user-supplied information underlying the determination, such as the actual search queries entered by the user, as well as other information, such as sensor data, medical records of the user, etc. When authorized by the user, the healthcare practitioner receives notice of the authorization (e.g. by email, text message, or other suitable mechanism) and a mechanism to securely access the second representation.

The disclosed examples thus may enable the convenient notification of a healthcare practitioner when an inference of a possible user health condition is detected via analyzing user-provided information not specifically solicited from the user for health care purposes. Representations of the inference and/or other data may be securely stored and transmitted in an encrypted manner to protect sensitive information.

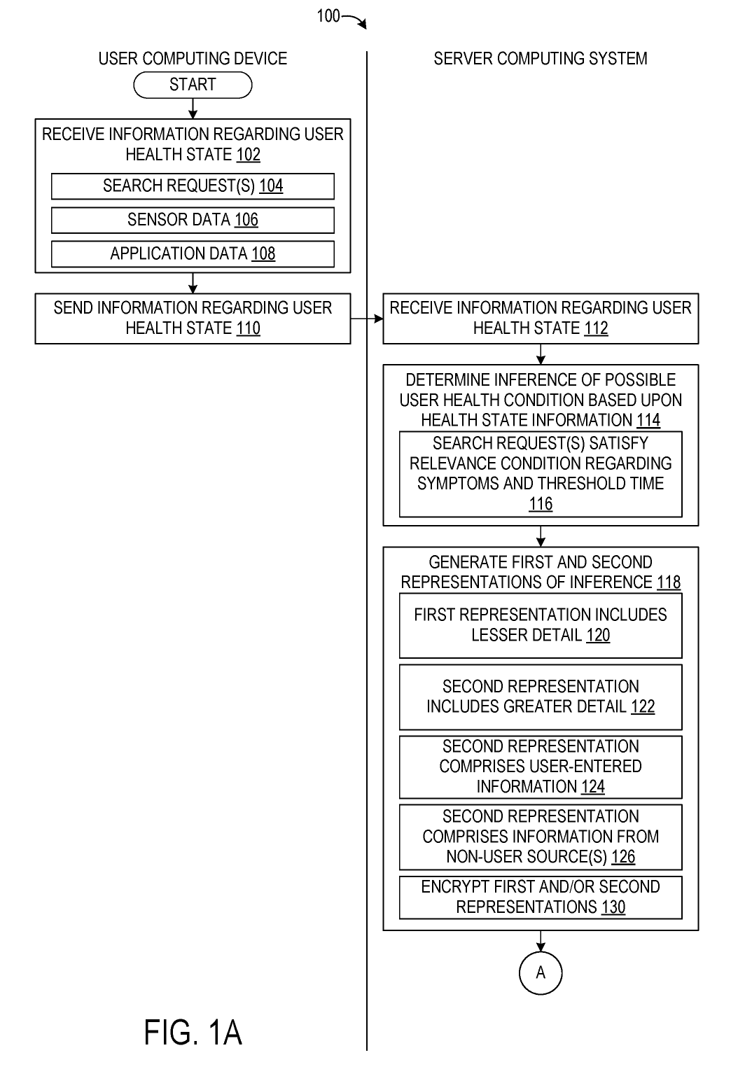

FIGS. 1A-1C show a flowchart illustrating a method 100 of providing representations of a possible health condition inference. Method 100 includes steps performed at a user computing device, a server computing system, and a healthcare practitioner computing device. It will be understood that method 100 may be performed on an opt-in basis, such that information relating to a user is not collected unless the user has consented to such collection.

At 102, method 100 includes receiving an input of information regarding a health state of a user at a computing device associated with the user. As an example, the input of information regarding the health state of the user may be determined from one or more search requests associated with the user (e.g. performed from a user's account on a computing device), as shown at 104. While many search requests entered by the user may not relate to healthcare topics, one or more search requests may include information related to symptoms experienced by the user, for example, to obtain information relating to causes and/or treatments of the symptoms, and health-related logic may identify such search requests,

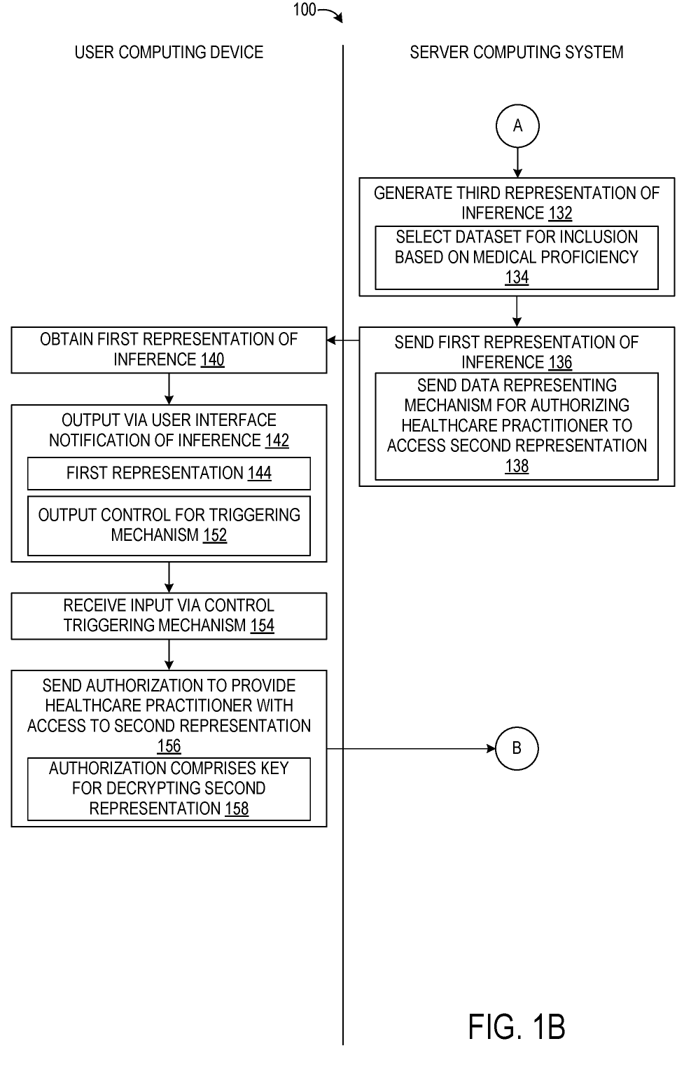

FIG. 2 shows an example user interface (UI) 200 for a search engine. UI 200 includes a search field 202 in which search requests can be entered via a suitable input device (e.g., by keyboard or microphone), and a control 204 that is selectable to query a search engine with the string entered in the search field. FIG. 2 also illustrates that search requests made via UI 200 may be uniquely associated with the users that made the requests. In the depicted example, UI 200 includes an indicator 206 displaying the name (“Jane Doe”) associated with an account currently logged into by the computing device or search service, enabling the query entered in search field 202 (“abdominal pain”) to be associated with the user shown.

As the user enters search strings, the strings may be analyzed for healthcare-related search terms by a server receiving the search strings. For example, the search strings may be compared individually or collectively to one or more relevance conditions to determine an inference of a possible health condition of the user, as described in further detail below. The relevance condition(s) may be defined such that a plurality of healthcare-related search strings are determined to satisfy the relevance condition(s) and trigger the determination of an inference of a possible health condition if the plurality of search strings are determined, collectively or individually, to have a threshold relevance with one another with regard to a specific health condition. The relevance condition also may define a time proximity of the searches to help determine whether the searches are related to a common issue. In this way, a related set of symptoms used to query the search engine over time may be analyzed to identify possible health conditions as they become apparent, and to track general changes in user health. As such, inputs of information regarding user health state may relate to any suitable period of time—e.g., a user health state may regard an instantaneous snapshot of user health, one or more trajectories of user health, short-term time periods of user health, and/or long-term time periods of user health). Similar UIs may be accessible from a plurality of computing devices operated by the user and linked to the user account, such as a mobile device, a work desktop, a home desktop, and a tablet.

In some examples, the input of information regarding the health state of the user alternatively or additionally may include sensor data associated with the user, as indicated at 106. Such sensor data may be collected by sensor(s) of a wearable device, such as a health-tracking band, for example. The sensor data may include data regarding user sleep, locomotion, heart rate, blood pressure, glucose level, ultraviolet light exposure, eye gaze, vocalization, and/or other types of user-related sensor data. While FIG. 1A depicts the reception of the sensor data at the user computing device, in other examples the sensor data may be sent from the wearable device directly to a server computing system.

Further, the input of information regarding the health state of the user alternatively or additionally may include application data associated with the user, as indicated at 108. Such application data may be derived from application(s) executed on one or more of the computing devices associated with the user. As examples, the application data may include calendar data appointment data), media consumption data (e.g., consumption habits, content preferences social media data (e.g., contacts, relationships, posts), and/or other types of user-related application data.

While not shown in FIG. 1A, in some examples the reception and/or supply of the input of information regarding the user health state may be informed by healthcare practitioner input. For example, a healthcare practitioner, or multiple healthcare practitioners associated by medical specialty, may specify the types of user-related data they should receive. Such healthcare practitioner specification may be used to screen (e.g., at the user inputting device and/or server computing system) received data so that user-related data provided to a healthcare practitioner complies with the specification made by that practitioner. In some examples, healthcare practitioner specification of desired user-related data may be provided in response to user input identifying the types of user-related data the user consents to make available.

At 110, method 100 includes sending the information regarding the health state of the user from the user computing device to a server computing system, and, at 112, receiving the information regarding the health state of the user at the server computing system. At 114, method 100 includes determining, at the server computing system, an inference of a possible health condition of the user based upon the information regarding the health state of the user. This determination may be based on the search requests, sensor data and/or application data, alone or in combination.

As indicated at 116, the inference may be determined based at least upon the one or more search requests satisfying a relevance condition. The relevance condition may be defined in any suitable manner. For example, the relevance condition may be established such that a set of one or more symptoms recognized as relating to a same health condition, and searched for within a threshold time proximity, trigger the determination of an inference of a possible health condition corresponding to the searched symptoms. The relevance condition also may consider search request content, number, times, and/or any other suitable criteria.

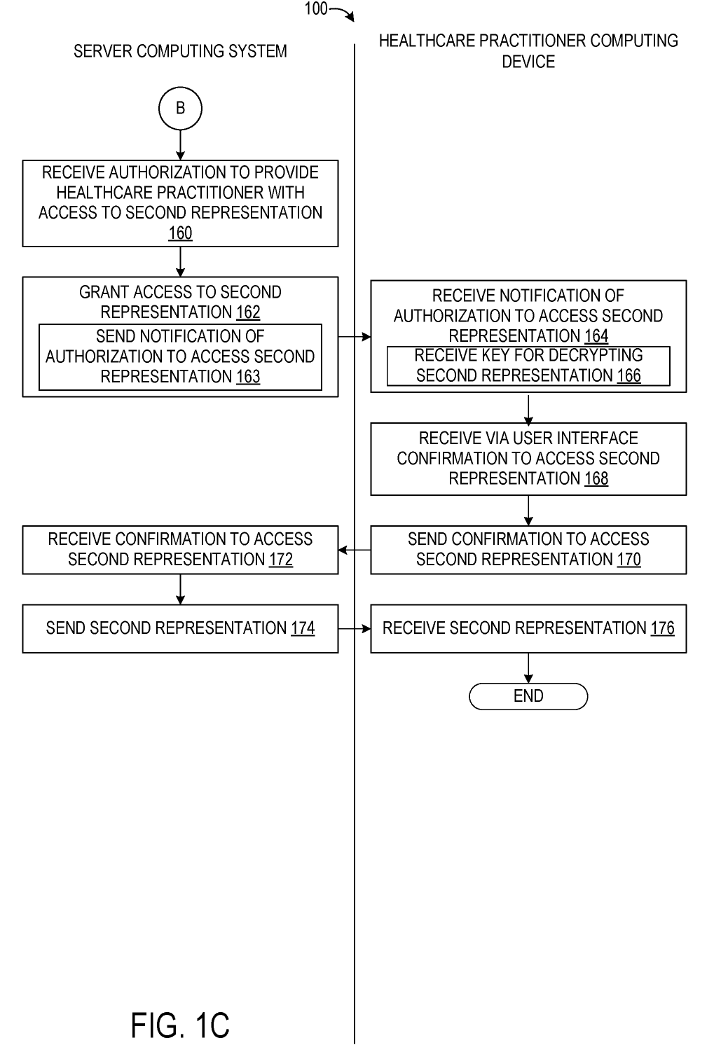

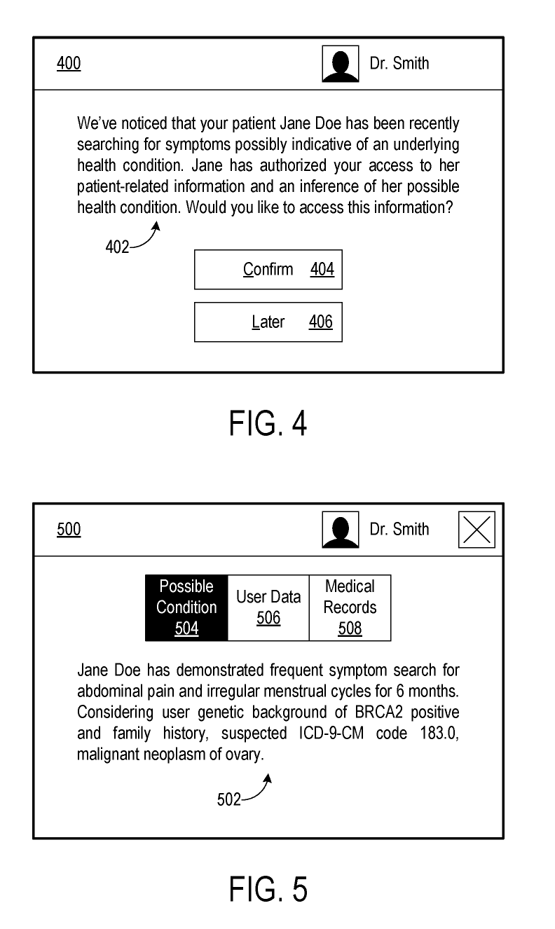

In response to determining that the relevance condition is satisfied, method 100 includes, at 118, generating first and second representations of the inference at the server computing system. The first representation may be configured for provision to the user, whereas the second representation may be configured for provision to a healthcare practitioner primary care physician, specialist) associated with the user. Accordingly, the content included in the first and second representations differs. For example, as indicated at 120, the first representation of the inference may include a lesser amount of detail regarding the possible health condition, and the second representation may include a greater amount of detail regarding the possible health condition, as indicated at 122, such as an identification of the possible condition and medical terms of art. Examples of the first and second representations are described below with reference to FIGS. 3 and 5, respectively.

As indicated at 124, the second representation further may include the health state information input at 102, such as search request information (e.g. search terms, results read, number of searches, times of searches, etc.). The second representation alternatively or additionally may include sensor data and/or application data associated with the user, as described above. The provision of user-initiated search request(s) may provide a straightforward mechanism with which insight into the health state of the user may be gained by the healthcare professional, as such search requests may often assume the form of natural language queries. When supplied in this from, the search request(s) may be semantically simple and understandable to a degree that other forms of user-related data may not be. Further, the provision of multiple forms of user-related data may increase the accuracy and comprehensiveness of the inference of the possible health condition.

Additionally, as indicated at 126, the second representation may include information regarding the health state of the user obtained from source(s) other than the user, such as medical records that the user has consented to share with the user's healthcare practitioners. Such medical records may be obtained in any suitable manner, such as via in-person interview, telephonic interview, etc. Such information may include medical device data (e.g., blood pressure readings, glucometer readings), medical test data, blood test data or other chemistry data, family data, genetic data, historical data regarding previous engagement with the user's healthcare practitioners and/or behavioral data regarding the user previously gathered by the user's healthcare practitioners, for example.

As described above, in some examples the representation may provide information regarding the possible health condition without specifically identifying a possible health condition, whereas the second representation may identify the possible health condition. In this way, user-related data that is potentially suggestive of a possible health condition can be passed to the healthcare practitioner for examination and possible diagnosis without unnecessarily alarming the user. Further, the potential inclusion in the second representation of the various datatypes described above may provide the healthcare practitioner with additional information to make accurate diagnoses using a substantially comprehensive dataset regarding the user. The generation and provision of the second representation may be substantially automated, thereby reducing the barriers to the self-reporting of data by the user to a healthcare practitioner.

The first and second representations of the inference may be encrypted upon generation, as indicated at 130. Any suitable encryption scheme may be utilized, such as key-based encryption methods. As a more specific example, the first representation may be encrypted and decrypted via a public/private key pair associated with the user. The second representation may be encrypted both with the public/private key pair of the user (either the same or different than used for the first representation) and also via a public/private key pair of the healthcare practitioner. In some examples, one or more of the encryption/decryption keys used with the first and second representations may be unique to each instance in which a representation is generated. Further, in other examples the first and/or second representations may be encrypted with one or more keys not associated with the user and/or healthcare practitioner. Still further, non-key-based methods of encrypting the first and/or second representation are contemplated.

Encrypting the first and/or second representations described above may facilitate secured communication between users and healthcare practitioners. In this way, personally-identifiable information (PII) can be secured, while respecting legal requirements regarding its handling and disclosure.

Continuing with FIG. 1B, at 132, method 100 optionally may include generating, at the server computing system, a third representation of the inference for provision to another user (and other representations as well, depending upon how many practitioners are to be sent data relevant to their respective practices). As an example, the other user may he another healthcare provider for the user, such as a specialist, physical therapist, or mental health practitioner. A dataset selected for inclusion in a second representation configured for provision to a primary care physician may differ from a dataset selected for inclusion in a third representation configured for provision to a non-primary care physician, for example. As indicated at 134, generating the third representation may comprise selecting a dataset for inclusion in the third representation based on a medical proficiency of the other user, as well as other factors, such as a level of access privilege the other user has to healthcare information of the user, relationship of the other user to the user (e.g., family member, caregiver), and/or whether the other user has been nominated to receive health information regarding the user. The third representation may be encrypted as described above.

At 136, method 100 includes sending the first representation of the inference of the possible health condition of the user to the user computing device. As indicated at 138, sending the first representation of the inference may include sending a mechanism for authorizing the healthcare practitioner to access the second representation of the inference. Such mechanisms also may be provided for any additional representations of the inference, e.g. for a specialist. In some examples, the mechanism sent at 138 may be sent at a different time than the first representation of the inference. For example, a user may pre-authorize the sending of health inferences to one or more selected healthcare practitioners. Additionally, a user may specify that an inference having a sufficiently high confidence score may be sent to a healthcare practitioner without authorization, while inferences of lower confidence require specific authorization. Examples of confidence scores are described below.

At 140, method 100 includes obtaining the first representation of the inference and the data representing the mechanism for authorizing the healthcare practitioner to access the second representation, and at 142, outputting a notification via a user interface. As indicated at 144, the notification may comprise the first representation of the inference, and at 152, a user-selectable control for triggering the mechanism to share the second representation with a healthcare practitioner.

FIG. 3 shows an example UI 300 displaying a notification 302 comprising an example first representation of an inference of a possible health condition. The first representation identifies at least some of the symptom(s) that have been searched for using the linked account, and alludes to the possibility that these symptoms may be suggestive of a possible health condition. Notification 302 further includes a request for consent from the user to share information regarding the inference with the healthcare practitioner associated with the user. In the depicted example, control 304 is selectable to display a message regarding the information that will be shared with the healthcare practitioner, should such sharing be authorized. The message may include a summary of content in the second representation. For example, the message may identify the datatypes included in the second representation, which, depending on user-associated data availability, may comprise one or more of search request(s), sensor data, application data, and medical records (e.g. test results, family history, genetic information), among other datatypes described above. In some examples, these datatype categories may be conveyed without identifying any of the specific data included therein.

UI 300 also includes a control 306 selectable for triggering the mechanism and authorizing the healthcare practitioner to access the second representation. UI 300 further includes a control 308 selectable to dismiss notification 302 and bypass the mechanism, in which case authorization to access the second representation is not provided to the healthcare practitioner.

Returning to FIG. 1B, at 154, method 100 includes receiving an input via the user-selectable control (e.g., selection of control 212) triggering the mechanism, and in response, at 156, sending authorization to provide the healthcare practitioner with access to the second representation of the inference. As indicated at 158, in some examples sending authorization to provide the healthcare practitioner with access to the second representation may comprise sending a decryption key associated with the user for decrypting the second representation. In other examples, the decryption key may be obtained by the healthcare practitioner from another entity, such as a key authority. Further, in other examples the decryption key may not be associated with the user.

While not shown in FIG. 1B, a user may specify via user input aspects of user-related data that may be shared with the healthcare practitioner. For example, a user may he provided with a mechanism to select which data (by specific item of information, by category of information, etc.) to be shared, and also may specify information to be excluded. As another example, user input may identify user-related data to be redacted (e.g., sensitive search request(s)). Further, the user may be prompted to authorize healthcare practitioner access to the second representation at any suitable frequency. As examples, authorization may be prompted in response to each generated instance of a second representation, once upon establishing a relationship with a healthcare practitioner, or once upon linking an account to a search engine, among other suitable times. As such, where pre-authorization is provided, a healthcare practitioner may be automatically notified of the availability of a representation of a possible health condition inference in response to the determination of the inference without obtaining specific user consent for that instance. The collection of user authorization at an initial instance without subsequent solicitation of user authorization may enable unobtrusive healthcare monitoring while respecting user consent.

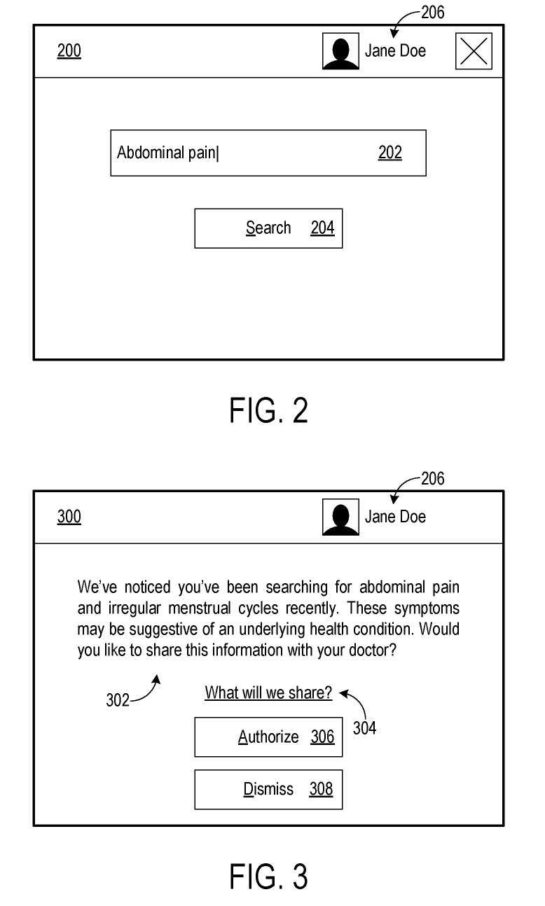

Continuing with FIG. 1C, at 160, method 100 includes receiving, at the server computing system, the authorization to provide the healthcare practitioner with access to the second representation of the inference. In some examples, receiving the authorization may include receiving the user-associated key for decrypting the second representation. At 162, method 100 includes, granting, at the server computing system, access to the second representation by the healthcare practitioner in response to receiving the authorization. As indicated at 163, granting access to the second representation may include sending a notification of the authorization to access the second representation from the server computing system to a computing device associated with the healthcare practitioner. At 164, method 100 includes receiving, at the healthcare practitioner computing device, the notification of the authorization to access the second representation. As indicated at 166, receiving the notification of the authorization may include receiving a decryption key for decrypting the second representation, such as the user-associated decryption key described above or another decryption key not associated with the user. As such, granting access to the second representation at 162 may include sending the user-associated decryption key from the server computing system to the healthcare practitioner computing device, or otherwise making access to the second representation available to the healthcare practitioner computing device. FIG. 4 shows an example UI 400 displaying an example of such a notification 402.

Returning to FIG. 1C, at 168, method 100 includes receiving, at the healthcare practitioner computing device, confirmation to access the second representation of the possible health condition inference via a user interface. Briefly referring again to FIG. 4, UI 400 includes a control 404 selectable for confirming access to the second representation by the healthcare practitioner. UI 400 further includes a control 406 selectable to dismiss notification 402 and refuse access to the second representation. In some examples, dismissal of notification 402 via selection of control 406 may be followed by redisplaying the notification at a later time. Continuing with FIG. 1C, at 170, method 100 includes sending, from the healthcare practitioner computing device, confirmation to access the second representation (e.g., in response to reception of the confirmation to access the second representation as received via selection of control 404). Further, at 172, method 100 includes receiving, at the server computing system, the confirmation to access the second representation from the healthcare practitioner computing device, and, at 174, sending the second representation from the server computing system. At 176, method 100 includes receiving the second representation at the healthcare practitioner computing device for presentation to the healthcare practitioner.

FIG. 5 shows an example UI 500 operable to display a second representation of possible health condition inferences to a healthcare practitioner. In the depicted example, UI 500 includes a notification 502 conveying the second representation in text form, wherein the second representation identifies the possible health condition of the user determined at 114 of method 100. Notification 502 may include other information, such as one or more of the symptom(s) and/or how far apart in time the possible symptoms were searched. FIG. 5 also illustrates how the possible health condition may be determined based on medical records information, as described above. For example, notification 502 conveys that the possible health condition is determined based on genetic information and family history associated with the user, as well as the search requests associated with the user.

UI 500 may be operable to display information associated with the user other than notification 502. For example, UI 500 includes a plurality of controls respectively selectable to display corresponding information associated with the user, such as a control 504 selectable to display the second representation of the inference (e.g., via notification 502) and a control 506 selectable to display user-related data. As examples, control 506 may be selectable to display the search queries entered by the user with which the inference was determined (e.g., selectable to display their content, number, time), sensor data associated with the user (e.g., collected by sensor(s) wearable device(s) worn by the user as described above), and application data associated with the user (e.g., applications executed on computing device(s) associated with the user as described above). UI 500 may further include a control 508 selectable to display medical records associated with the user (e.g., non-user source information described above such as one or more of medical history, family history, genetic information, test results, medical device readings, behavioral information, chemistry information; demographic, diagnosis, and/or population statistics). Alternative implementations are contemplated in which the entirety of user-related data is displayable in a single view (e.g., selectable via a common control), and in which additional controls are provided for respective categories of user-related data (e.g., respective controls for each of user-related search request(s), sensor data, application data, non-user source data).

As described above, the provision of user-related search request(s) may provide a straightforward dataset for the healthcare practitioner to obtain insight into the user health state, as the search requests may frequently be phrased as natural language phrases. The semantic simplicity of search request(s) may be greater than that of other user-related data types, enabling insight into the user health state to be obtained in a faster manner. Further, the provision of multiple user-related data-types may increase the accuracy and comprehensiveness of healthcare practitioner insight. As an example, user-related application data such as social media activity performed by the user may provide additional context to search request(s) performed by the user.

The determination of an inference of a possible health condition may be triggered in various manners. As described above, one or more search requests for terms that may represent related symptoms and that occur within a threshold time proximity may meet a recognized relevance condition and trigger determination of an inference. The relevance condition may consider search request content, number, times, and/or any other suitable criteria. In some examples, the relevance condition may be defined such that sensor data and/or application data associated with a user that may be considered anomalous may trigger determination of an inference. For example, sensor data collected by a wearable device worn by the user that indicates an increasing trend in resting heart rate, or that indicates rising blood pressure, may trigger determination of an inference, for example.

Further, in some examples at least a portion of a relevance condition may be defined by a healthcare practitioner and/or a user for which the relevance condition is evaluated. The relevance condition may be defined in this manner so that a determination of a possible health condition inference is triggered if the determination meets a desired confidence level, enabling user adjustment of the sensitivity of inference determination. For example, a healthcare practitioner may define a minimum number and a maximum duration in which a set of related search terms having at least the minimum number must be searched for within the maximum duration to trigger inference determination. In this way, determinations that do not meet the desired confidence level yet would otherwise be made may be bypassed.

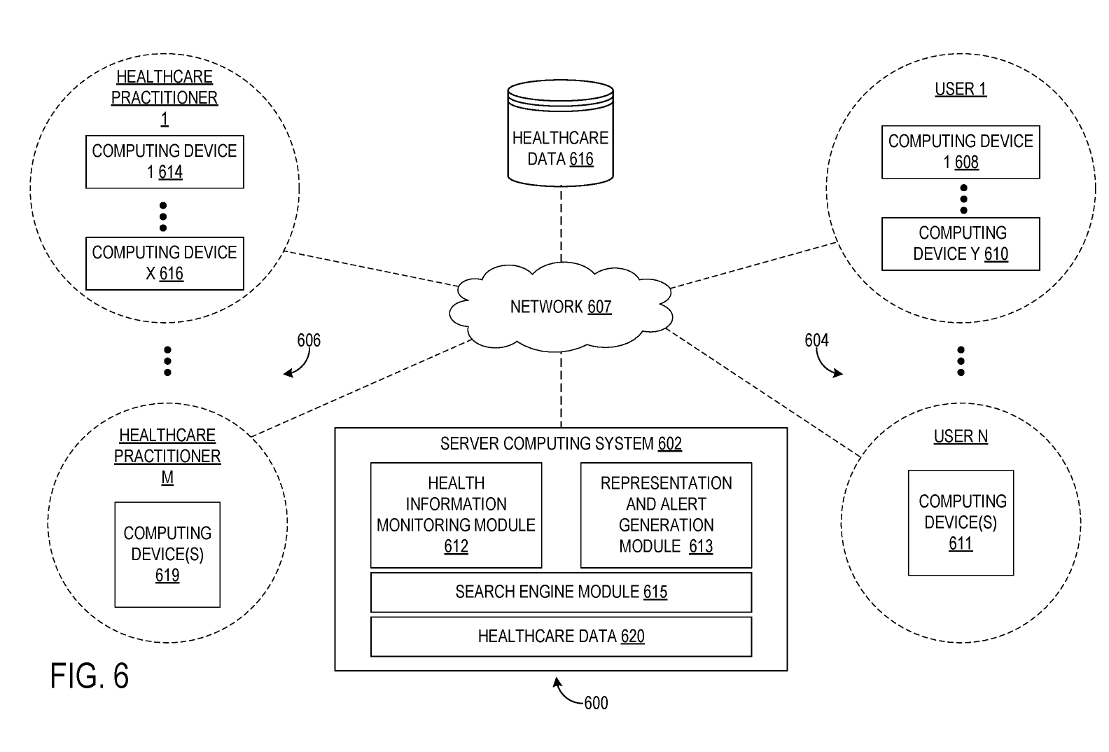

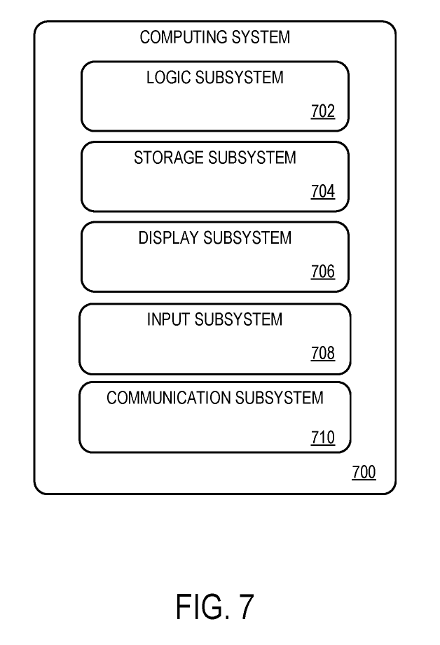

FIG. 6 shows an example system 600 that may be used to perform method 100 for a plurality of users and medical practitioners. System 600 includes a server computing system 602, a plurality of user computing devices 604, and a plurality of healthcare practitioner computing devices 606. Server system 602 and the user and practitioner computing devices are communicatively coupled via a network 607, which may assume any suitable form. Example computing system hardware is described below with reference to FIG. 7.

Computing devices for a first user are shown as 608 and 610, and computing devices for an nth user are shown at 611. Likewise, computing devices for a first healthcare practitioner are shown as 614 and 616, and computing device(s) for a mth healthcare practitioner are shown at 619. Examples of such computing devices include mobile computing devices, desktop computers, laptop computers, tablet computers, wearable devices, holographic devices, and mobile devices. The user computer devices, such as mobile computing devices and/or wearable computing devices, may comprise one or more sensors operable to collect sensor data regarding the user when worn by the user.

Computing device(s) associated with each user include a logic machine and a storage machine holding instructions executable by the logic machine executable to perform the relevant processes of method 100, among other processes. For example, the instructions may be executable to receive an input of information regarding a health state of a user, such as one or more search requests associated with the user, sensor data associated with the user, and/or application data associated with the user. The instructions further may be executable to send the information regarding the health state of the user to server computing system 602, and to obtain, from server computing system 606, an inference of a possible health condition of the user, wherein the inference is based upon the information regarding the health state of the user. The instructions further may be executable to output a notification (e.g., notification 302 of FIG. 3) of the inference via a user interface such as UI 300 (FIG. 3). The notification may comprise a first representation of the inference configured for provision to the user, which may comprise a lesser amount of detail regarding the possible health condition relative to a greater amount of detail comprised by the second representation (e.g. which may include a term of art recognizable by a healthcare practitioner as identifying the possible health condition). The first representation may be derived from computing device interactions of the user, and may be encrypted with an encryption key associated with the user. The UI may comprise a display of a user interface control (e.g., control 306) with a request for consent from the user for authorizing the healthcare practitioner to access the second representation.

The instructions further may be executable to receive data representing a mechanism for authorizing the healthcare practitioner to access the second representation of the inference. The second representation may be configured for provision to the healthcare practitioner associated with the user, and may comprise a representation of the input of the information regarding the health state of the user. The second representation may comprise a representation of the one or more search requests made by the user, biometric data regarding the user, and/or diagnostic information regarding the user. The input of the information regarding the health state of the user may be supplied by the user, and the second representation may comprise additional information regarding the health state of the user obtained from source(s) other than the user. The instructions may be executable to output via a UI (e.g., UI 300 of FIG. 3) a user-selectable control (e.g., control 306) for triggering the mechanism, to receive an input via the user-selectable control triggering the mechanism, and, in response, cause authorization to be sent to provide the healthcare practitioner with access to the second representation of the inference. In some examples, sending authorization to provide the healthcare practitioner with access to the second representation may comprise sending a decryption key (e.g., associated with the user) for decrypting the second representation.

Server computing system 602 includes one or more computing devices configured to serve client requests (e.g. requests from the depicted user and medical practitioner computing devices), and includes health-related logic configured to determine an inference of a possible medical condition in some instances. For example, server computing system 602 includes a health information monitoring module 612 configured to apply relevance conditions and determine inferences of possible health conditions. The server computing system 602 also includes a representation and alert generation module 613 configured to generate different representations of an inferred health condition and to provide alerts to users based upon the representations. The server computing system 602 further includes a search engine module 615 configured to receive search request(s) associated with a user and to provide results in response to received search requests (e.g., by crawling the Internet or other network(s) for relevant information). The server computing system 602 may include any other suitable modules as well.

More specifically, the health information monitoring module 612 may comprise instructions executable to monitor received search requests associated with a user, and based upon the one or more search requests, output determined inferences of possible health conditions. The one or more search requests may be received via search engine module 615, for example, and/or other search engine(s) communicatively coupled to server computing system 602. Such inferences may be determined in response to the one or more search requests satisfying a relevance condition for any of a plurality of possible health conditions, as described above.

Representation and alert generation module 613 may comprise instructions executable to receive notifications of possible health conditions from health information monitoring module 612, and to generate representations of possible health conditions based upon such alerts. In some examples, locally hosted healthcare data 620, such as diagnostic information, medical records for individuals, and/or any other suitable healthcare-related information, may be accessed in generating representations configured for provision to healthcare practitioners. Further, remotely stored healthcare data also may be accessed, as indicated at 616.

The server computing system further may be executable to send to a remote computing device associated with a user a first representation of an inference of a possible health condition. In addition to information on the possible health condition, the first representation also may comprise data representing a mechanism for authorizing a healthcare practitioner of the user to access a second representation of the inference. The instructions further may be executable to receive from a user authorization to provide the healthcare practitioner with access to the second representation of the inference, and, in response, grant access to the second representation of the inference by the healthcare practitioner. Granting access to the second representation may comprise providing a mechanism for decrypting the second representation, such as providing a first decryption key associated with the user and a second decryption key associated with the healthcare practitioner. The instructions further may be executable to generate a third representation of the inference configured for provision to another user, which may be based on a medical proficiency of the other user.

Computing device(s) associated with the healthcare practitioner each comprise(s) a logic machine and a storage machine holding instructions executable by the logic machine. The instructions may be executable to receive from a remote computing device a notification of the authorization to access the second (or third, etc.) representation of the inference of the possible health condition of the user. The authorization may be provided by the user, and the representation of the inference of the possible health condition may be derived from computing device interactions of the user. The authorization may comprise a decryption key associated with the user for decrypting the representation. The instructions further may be executable to receive via a user input device confirmation to access the representation of the inference of the possible health condition of the user. The confirmation may be supplied via selection of control 404 at UI 400 of FIG. 4 for example. The instructions may be executable to send the confirmation to access the representation of the inference to the remote computing device, and to receive the representation of the inference of the possible health condition of the user. The representation may he conveyed via notification 502 of UI 500 of FIG. 5, for example.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. Computing system 700 may take the form of one or more personal computers server computers, tablet computers, home-entertainment computers, network computing devices, gaming devices, mobile computing devices, mobile communication devices (e.g., smart phone), and/or other computing devices.

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may he integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module” may be used to describe an aspect of computing system 700 implemented to perform a particular function. In some cases, a module may be instantiated via logic machine 702 executing instructions held by storage machine 704. It will be understood that different modules may be instantiated from the same application, service, code block, object, library, routine, API, function, etc. Likewise, the same module may be instantiated by different applications, services, code blocks, objects, routines, APIs, functions, etc. The term “module” may encompass individual or groups of executable files, data files, libraries, drivers, scripts, database records, etc.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

Another example provides a computing device comprising a logic machine and a storage machine holding instructions executable by the logic machine to receive an input of information regarding a health state of a user, obtain, based upon the information regarding the health state of the user, an inference of a possible health condition of the user, output a notification of the inference via a user interface, the notification comprising a first representation of the inference, receive data representing a mechanism for authorizing a healthcare practitioner to access a second representation of the inference, output via the user interface a user-selectable control for triggering the mechanism, receive an input a the user-selectable control triggering the mechanism, and, in response, send authorization to provide the healthcare practitioner with access to the second representation of the inference. In such an example, the first representation alternatively or additionally may comprise a lesser amount of detail regarding the possible health condition, and the second representation alternatively or additionally may comprise a greater amount of detail regarding the possible health condition. In such an example, the second representation alternatively or additionally may identify the possible health condition. In such an example, the second representation alternatively or additionally may comprise a representation of the input of the information regarding the health state of the user. In such an example, the instructions executable to receive the input of the information regarding the health state of the user alternatively or additionally may be executable to receive information regarding one or more search requests associated with the user. In such an example, the instructions executable to receive the input of the information regarding the health state of the user alternatively or additionally may be executable to receive information regarding one or more search requests associated with the user. In such an example, the user interface alternatively or additionally may comprise a user interface control selectable to grant the healthcare practitioner authorization to access the second representation. In such an example, the first representation alternatively or additionally may comprise a message regarding the information that will be shared with the healthcare practitioner. In such an example, the first representation alternatively or additionally may be encrypted. In such an example, the instructions executable to send authorization to provide the healthcare practitioner with access to the second representation alternatively or additionally may be executable to provide a decryption key for decrypting the second representation. In such an example, the instructions alternatively or additionally may be executable to receive the input of the information regarding the health state of the user as supplied by the user, and the second representation alternatively or additionally may comprise additional information regarding the health state of the user not supplied by the user. In such an example, the second representation alternatively or additionally may comprise biometric data regarding the user, medical device data regarding the user, medical test data regarding the user, chemistry data regarding the user, historical data regarding the user, family data regarding the user, genetic data regarding the user, and/or behavioral data regarding the user.

Another example provides, on a computing system, a method comprising receiving one or more search requests associated with a user, based upon the one or more search requests, determining an inference of a possible health condition of the user, receiving authorization to provide a healthcare practitioner with access to a representation of the inference, and, in response, granting access to the representation of the inference by the healthcare practitioner. In such an example, the representation alternatively or additionally may be a second representation, and the method alternatively or additionally may comprise generating a first representation of the inference and the second representation of the inference, the first representation being configured for provision to the user, and the second representation being configured for provision to the healthcare practitioner associated with the user, and sending, to a remote computing device associated with the user, the first representation of the inference. In such an example, the first representation alternatively or additionally may comprise a lesser amount of detail regarding the possible health condition, and the second representation alternatively or additionally may comprise a greater amount of detail regarding the possible health condition. In such an example, the second representation alternatively or additionally may comprise a representation of the one or more search requests. In such an example, the second representation alternatively or additionally may be encrypted with a first encryption key associated with the user and a second encryption key associated with the healthcare practitioner, and granting access to the second representation alternatively or additionally may comprise sending a first decryption key associated with the user and a second decryption key associated with the healthcare practitioner to a remote computing device associated with the healthcare practitioner. In such an example, the method alternatively or additionally may comprise generating a third representation of the inference configured for provision to another user.

Another example provides a computing device comprising a logic machine and a storage machine holding instructions executable by the logic machine to receive from a remote computing device a notification of an authorization to access a representation of an inference of a possible health condition of a user, the authorization being provided by the user, and the representation of the inference of the possible health condition being derived from computing device interactions of the user, receive via a user input device confirmation to access the representation of the inference of the possible health condition of the user, send the confirmation to access the representation of the inference of the possible health condition of the user to the remote computing device, and receive the representation of the inference of the possible health condition of the user. In such an example, the computing device interactions of the user alternatively or additionally may comprise one or more search requests made by the user, and the representation alternatively or additionally may comprise one or more results respectively associated with the one or more search requests made by the user. In such an example, the authorization alternatively or additionally may comprise a decryption key associated with the user for decrypting the representation.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
a logic machine; and
a storage machine holding instructions executable by the logic machine to receive an input of information regarding a health state of a user;
obtain, based upon the information regarding the health state of the user, an inference of a possible health condition of the user;
output a notification of the inference via a user interface, the notification comprising a first representation of the inference;
receive data representing a mechanism for authorizing a healthcare practitioner to access a second representation of the inference;
output via the user interface a user-selectable control for triggering the mechanism;
receive an input via the user-selectable control triggering the mechanism; and
in response, send authorization to provide the healthcare practitioner with access to the second representation of the inference.

2. The computing device of claim 1, wherein the first representation comprises a lesser amount of detail regarding the possible health condition, and wherein the second representation comprises a greater amount of detail regarding the possible health condition.

3. The computing device of claim 1, wherein the second representation identifies the possible health condition.

4. The computing device of claim 1, wherein the second representation comprises a representation of the input of the information regarding the health state of the user.

5. The computing device of claim 4, wherein the instructions executable to receive the input of the information regarding the health state of the user are executable to receive information regarding one or more search requests associated with the user.

6. The computing device of claim 1, wherein the user interface comprises a user interface control selectable to grant the healthcare practitioner authorization to access the second representation.

7. The computing device of claim 1, wherein the first representation comprises a message regarding the information that will be shared with the healthcare practitioner.

8. The computing device of claim 1, wherein the first representation is encrypted.

9. The computing device of claim 1, wherein the instructions executable to send authorization to provide the healthcare practitioner with access to the second representation are executable to provide a decryption key for decrypting the second representation.

10. The computing device of claim 1, wherein the instructions are executable to receive the input of the information regarding the health state of the user as supplied by the user, and wherein the second representation comprises additional information regarding the health state of the user not supplied by the user.

11. The computing device of claim 1, wherein the second representation comprises biometric data regarding the user, medical device data regarding the user, medical test data regarding the user, chemistry data regarding the user, historical data regarding the user, family data regarding the user, genetic data regarding the user, and/or behavioral data regarding the user.

12. On a computing system, a method comprising:
receiving one or more search requests associated with a user;
based upon the one or more search requests, determining an inference of a possible health condition of the user;
receiving authorization to provide a healthcare practitioner with access to a representation of the inference; and
in response, granting access to the representation of the inference by the healthcare practitioner.

13. The method of claim 12, wherein the representation is a second representation, the method further comprising generating a first representation of the inference and the second representation of the inference, the first representation being configured for provision to the user, and the second representation being configured for provision to the healthcare practitioner associated with the user; and
sending, to a remote computing device associated with the user, the first representation of the inference.

14. The method of claim 12, wherein the first representation comprises a lesser amount of detail regarding the possible health condition, and wherein the second representation comprises a greater amount of detail regarding the possible health condition.

15. The method of claim 12, wherein the second representation comprises a representation of the one or more search requests.

16. The method of claim 12, wherein the second representation is encrypted with a first encryption key associated with the user and a second encryption key associated with the healthcare practitioner, and wherein granting access to the second representation comprises sending a first decryption key associated with the user and a second decryption key associated with the healthcare practitioner to a remote computing device associated with the healthcare practitioner.

17. The method of claim 2, further comprising generating a third representation of the inference configured for provision to another user.

18. A computing device, comprising:
a logic machine; and
a storage machine holding instructions executable by the logic machine to
receive from a remote computing device a notification of an authorization to access a representation of an inference of a possible health condition of a user, the authorization being provided by the user, and the representation of the inference of the possible health condition being derived from computing device interactions of the user;
receive via a user input device confirmation to access the representation of the inference of the possible health condition of the user;
send the confirmation to access the representation of the inference of the possible health condition of the user to the remote computing device; and
receive the representation of the inference of the possible health condition of the user.

19. The computing device of claim 18, wherein the computing device interactions of the user comprise one or more search requests made by the user, and wherein the representation comprises one or more results respectively associated with the one or more search requests made by the user.

20. The computing device of claim 18, wherein the authorization comprises a decryption key associated with the user for decrypting the representation.
